(19) United States
(12) Patent Application Publication
(10) Pub. No.: US 2021/0068367 A1
(43) Pub. Date: Mar. 11, 2021

(54) Portable pet water feeder

(71) Applicant: JIANGSU ELS PLASTIC INDUSTRY CO., LTD., Yangzhou (CN)

(72) Inventors: Yuan Gong, Yangzhou (CN); Kang Zhao, Yangzhou (CN)

(73) Assignee: JIANGSU ELS PLASTIC INDUSTRY CO., LTD.

(21) Appl. No.: 17/030,417

(22) Filed: Sep. 24, 2020

Related U.S. Application Data
(63) Continuation of application No. PCT/CN2018/111141, filed on Oct. 22, 2018.

(30) Foreign Application Priority Data
Mar. 26, 2018 (CN) 201820419098.8

(51) Int. Cl. A01K 7/00

(52) U.S. Cl. CPC A01K 7/00

(57) ABSTRACT

The utility model discloses a portable pet water feeder, comprising a cup body and a drinking water slide cover, wherein the drinking water slide cover is sleeved on the outer wall of the cup body and is slidable along the outer wall of the cup body, the cup body is provided with an upper cover, the upper cover is provided with a water outlet nozzle, a partition plate is provided between the upper cover and the cup body, the partition plate is provided with a water outlet hole, a pressing water outlet component is provided in the upper cover, and the pressing water outlet component connects the water outlet hole and the water outlet nozzle. The portable pet water feeder comes with a drinking water slide cover for providing water by pressing, and is provided with a water locking switch, which is convenient and practical, safe and sanitary, and long in service life.

### TECHNICAL FIELD

The utility model relates to the field of pet drinking machinery, and in particular to a portable pet water feeder.

### BACKGROUND

At present, more and more people love to keep pets, and the diet and daily life of pets are also concerned by pet lovers.

When pets go out with their owners, people mostly use mineral water to feed their pets. In the process of unscrewing the cap and feeding water to the pets, it is easy for water to spill out, wasting water resources. Further, by doing so, it is easy to choke the pets. In addition, there are some portable pet water feeders on the market that provide water by pressing, but their internal mechanisms such as springs are immersed in water, which are prone to corrosion and affect their service life.

### SUMMARY

The technical problem to be solved by the utility model is to provide a portable pet water feeder, which comes with a drinking water slide cover for providing water by pressing and is provided with a water locking switch, which is convenient and practical, safe and sanitary, and long in service life.

In order to solve the above technical problems, the utility model provides a portable pet water feeder, comprising a cup body and a drinking water slide cover, wherein the drinking water slide cover is sleeved on the outer wall of the cup body and is slidable along the outer wall of the cup body, the cup body is provided with an upper cover, the upper cover is provided with a water outlet nozzle, a partition plate is provided between the upper cover and the cup body, the partition plate is provided with a water outlet hole, a pressing water outlet component is provided in the upper cover, and the pressing water outlet component connects the water outlet hole and the water outlet nozzle.

Preferably, the pressing water outlet component comprises a water guiding pipe, an insert block, a first spring and a button, one end of the water guiding pipe is connected to the water outlet nozzle, the other end thereof is connected to the water outlet hole, the pipe wall of the water guiding pipe is provided with a groove body, one end of the insert block is inserted into the water guiding pipe from the groove body, the other end of the insert block extends out of the pipe wall of the water guiding pipe and is connected with the button, and a first spring is provided between the button and the water guiding pipe.

Preferably, the end of the insert block is L-shaped, and the end of the insert block is provided in parallel with the pipe wall of the water guiding pipe.

Preferably, the partition plate is provided with an air inlet hole, the upper cover is further provided with a water locking component, the water locking component comprises a slider, a hole blocking member and a second spring, the slider is provided with a hole blocking member, the hole blocking member is provided toward the air inlet hole, and the outer wall of the hole blocking member is sleeved with a second spring.

Preferably, the top of the slider is provided with a first groove and a second groove with different depths, a water locking switch is provided on the upper cover, the water locking switch is provided with a protruding end, and the protruding end is provided perpendicular to the slider and buckled in the first groove or the second groove.

Preferably, a filter tray is provided in the cup body, and a filter purification component is placed in the filter tray.

Preferably, the filter purification component comprises a charcoal bag.

Preferably, the drinking slider is provided with a drinking cavity, and the water outlet nozzle is connected to the drinking cavity.

Compared with the prior art, the beneficial effects of the utility model areas follows.

1. The utility model is provided with a pulling-type drinking water slide cover, which serves as a “small bowl” for pets to drink water, which saves space and is convenient and practical.

2. The pressing water outlet component of the utility model is not immersed in water, and is provided independently of the waterway, which is long in service life, safe and sanitary.

3. The pet water feeder in the utility model is convenient to carry outdoors and is simple and convenient to use.

### BRIEF DESCRIPTION OF THE DRAWINGS

In order to more clearly describe the technical solutions in the embodiment technology of the utility model, the drawings needed in the technical description of the embodiments will be briefly introduced hereinafter. Obviously, the drawings in the following description are only some embodiments of the utility model. For those skilled in the art, other drawings can be obtained based on these drawings without creative work.

FIG. 1 is a schematic diagram of the structure according to the utility model;

FIG. 2 is a schematic cross-sectional diagram of the utility model;

FIG. 3 is an enlarged schematic diagram of FIG. 2 in area A;

FIG. 4 is a schematic diagram of the structure of a water locking component according to the utility model.

In the figures, 10—cup body, 20—drinking water slide cover, 30—upper cover, 40—water outlet nozzle, 41—button, 42—connector, 43—first spring, 44—fixed block, 45—insert block, 46—water guiding pipe, 50—partition plate, 51—air inlet hole, 60—water locking switch, 61—protruding end, 62—slider, 63—second spring, 64—hole blocking member, 65—first groove, 66—second groove, 70—filter tray, 71—charcoal bag.

### DESCRIPTION OF THE EMBODIMENTS

The technical solutions in the embodiments of the utility model will be clearly and completely described with reference to the drawings in the embodiments of the utility model. Obviously, the described embodiments are only some embodiments of the utility model, rather than all the embodiments. Based on the embodiments of the utility model, all other embodiments obtained by those skilled in the art without creative work shall fall within the protection scope of the utility model.

### Embodiment

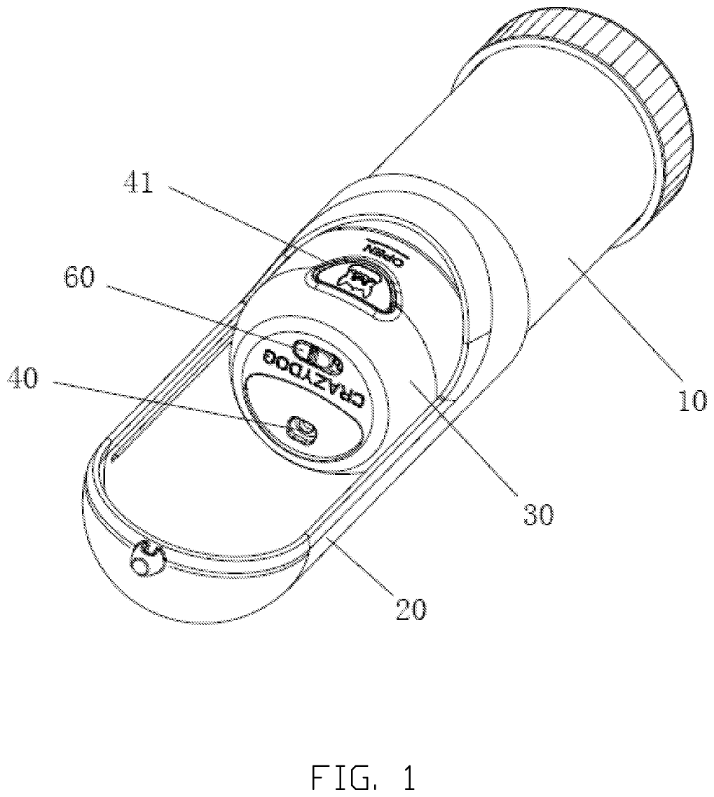

Referring to FIGS. 1 to 4, the utility model discloses a portable pet water feeder, comprising a cup body 10 and a drinking water slide cover 20, wherein the drinking water slide cover 20 is sleeved on the outer wall of the cup body 10 and is slidable along the outer wall of the cup body 10, the cup body 10 is provided with an upper cover 30, the upper cover 30 is provided with a water outlet nozzle 40, a partition plate 50 is provided between the upper cover 30 and the cup body 10, the partition plate 50 is provided with an air inlet hole 51 and a water outlet hole, a pressing water outlet component is provided in the upper cover 30, and the pressing water outlet component connects the water outlet hole 52 and the water outlet nozzle 40.

FIG. 1 shows a schematic diagram of the structure according to the utility model. The drinking water slide cover 20 is sleeved on the outer wall of the cup body 10, and the drinking water slide cover 20 is pulled open, which can be used as a “small bowl” for pets. The drinking water slide cover 20 is provided with a drinking cavity, and the water outlet nozzle 40 is connected to the drinking water slide cover 20, so that drinking water can flow into the drinking water slide cover 20 more easily. The upper cover 30 is provided with a button 41 and a water locking switch 60. The water locking switch 60 can move left and right. The water locking switch 60 is turned on and the button 41 is press, so that water will flow from the water outlet nozzle 40 into the drinking water slide cover 20, which is convenient for pets to drink water. When the pet has finished drinking water, the drinking water slide cover 20 is put away, which can be easily carried. The advantage of this drinking water slide cover is that it is convenient to store, and there is no need to prepare additional utensils for containing water.

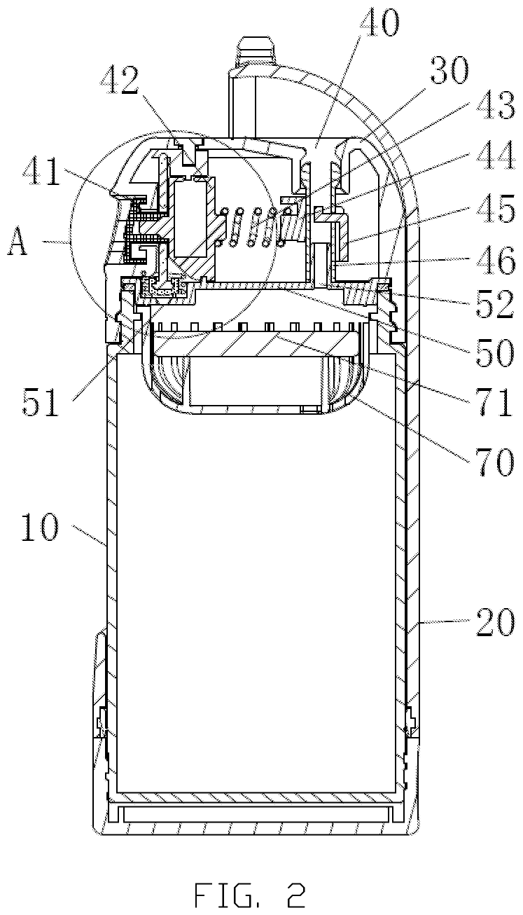

FIG. 2 shows a schematic cross-sectional diagram of the utility model. A partition plate 50 is provided between the upper cover 30 and the cup body 10, and the partition plate 50 is provided with an air inlet hole 51 and a water outlet hole 52. When the air inlet hole 51 is blocked, no water can flow from the water outlet hole 52. A pressing water outlet component is provided in the upper cover 30, and the pressing water outlet component comprises a water guiding pipe 46, an insert block 45, a first spring 43 and a button 41. One end of the water guiding pipe 46 is connected with the water outlet nozzle 40, and the other end thereof is connected with the water outlet hole 52. The water guiding pipe 46 is provided with a groove body, and the insert block 45 is vertically inserted into the water guiding pipe 46 from the groove body. The end of the insert block 45 inserted into the water guiding pipe 46 is L-shaped, and the end of the insert block is provided in parallel with the pipe wall of the water guiding pipe 46. The other end of the insert block 45 is connected to the button 41 through a connector 42. When the button 41 is pressed, the connector 42 and the insert block 45 move to the left, the water guiding pipe 46 is conducted, and water can flow out from the water guiding pipe 46. A fixing block 44 is provided on the left side of the water guiding pipe 46, and a first spring 43 is provided between the connector 42 and the fixing block 44. When the button 41 is released, the connector 42 will move to the left under the action of the first spring 43 and drive the insert block 45 to move to the left. The water guiding pipe 46 is blocked and water cannot flow out. This pressing water outlet component can pour different amounts of water as needed, and thus can more accurately control the outflow of water flow. A filter tray 70 is provided in the cup body 10, and a filter purification component is placed in the filter tray 70. In this embodiment, the filter purification component comprises a charcoal bag 71. The function of the filter purification component is to filter the drinking water to ensure that the pets drink healthy water.

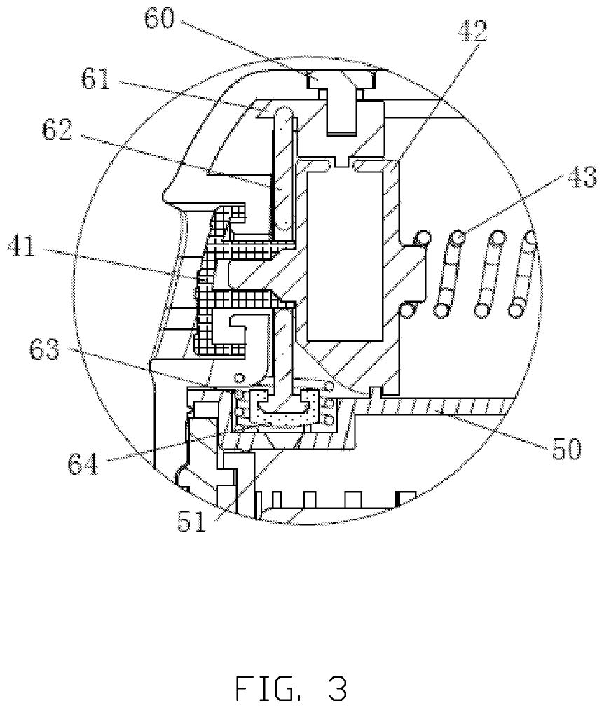

FIG. 3 shows an enlarged diagram of FIG. 2 in area A. A water locking component is further provided in the upper cover 30, and the function of the water locking component is to control whether the water flows out. The water locking component comprises a slider 62, a hole blocking member 64 and a second spring 63. The slider 62 is provided vertically. The hole blocking member 64 is provided on the lower side of the slider 62 and can move downward along with the slider 62 to block the air inlet hole 51. A second spring 63 is sleeved on the outer wall of the hole blocking member 64.

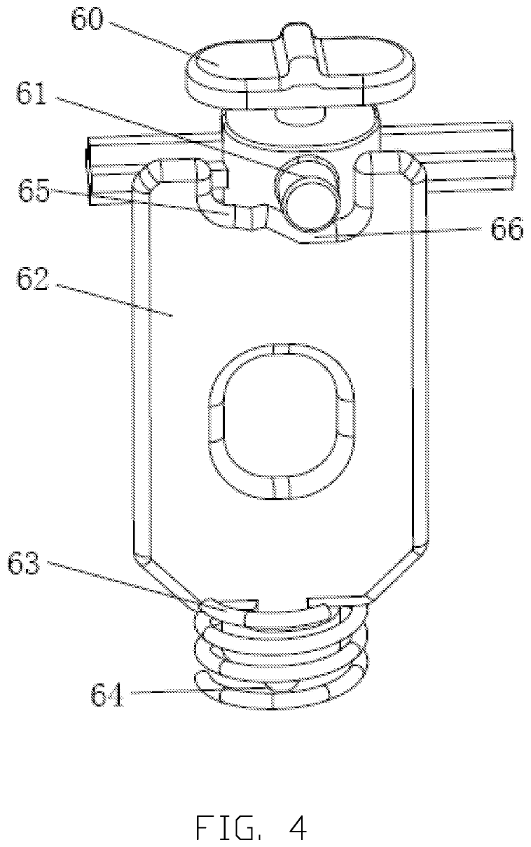

FIG. 4 is a schematic diagram of the structure of a water locking component. The top of the slider 62 is provided with a first groove 65 and a second groove 66 with different depths, and the second groove 66 is deeper than the first groove 65. A water locking switch 60 is provided on the upper cover 30. The water locking switch 60 is provided on the upper cover 30, and the water locking switch 60 can slide horizontally. The water locking switch is provided with a protruding end 61, the protruding end 61 is provided perpendicular to the slider 62, and the protruding end 61 is buckled in the first groove 65 or the second groove 66. The water locking switch 60 moves to the left, the protruding end 61 is buckled on the first groove 65, the slider 62 moves downward, the hole blocking member 64 moves downward to block the air inlet hole 51, and the pet water feeder cannot discharge water. The water locking switch 60 moves to the right, the protruding end 61 is buckled in the second groove 66, the slider 62 moves upward under the action of the second spring 63, and the hole blocking member 64 also moves upward with the slider 62. Air can enter through air inlet hole 51. The water feeder transforms to the state of FIG. 1, the button 41 is pressed, and the pet water feeder will discharge water. The function of the water lock component is to prevent water leakage by accidentally pressing the button 41. Due to the small caliber of the water outlet hole 52, as long as the water locking switch 60 is turned off, no matter whether the button 41 is pressed or not, the water outlet nozzle 40 will not discharge water.

In this embodiment, since the pressing water outlet component and the water locking component are provided on the upper side of the partition plate 50, the water locking component and the mechanism within the spring of the pressing water outlet component are not immersed in the water, and are provided independently of the waterway, which can extend the service life and is more healthy and sanitary.

The above description of the disclosed embodiments enables those skilled in the art to realize or use the utility model. Various modifications to these embodiments will be obvious to those skilled in the art. The general principles defined herein can be implemented in other embodiments without departing from the spirit or scope of the utility model. Therefore, the utility model will not be limited to the embodiments shown herein, but should conform to the widest scope consistent with the principles and novel points disclosed herein.

What is claimed is:

1. A portable pet water feeder, comprising a cup body and a drinking water slide cover, wherein the drinking water slide cover is sleeved on the outer wall of the cup body and is slidable along the outer wall of the cup body, the cup body is provided with an upper cover, the upper cover is provided with a water outlet nozzle, a partition plate is provided between the upper cover and the cup body, the partition plate is provided with a water outlet hole, a pressing water outlet component is provided in the upper cover, and the pressing water outlet component connects the water outlet hole and the water outlet nozzle.

2. The portable pet water feeder according to claim 1, wherein the pressing water outlet component comprises a water guiding pipe, an insert block, a first spring and a button, one end of the water guiding pipe is connected to the water outlet nozzle, the other end thereof is connected to the water outlet hole, the pipe wall of the water guiding pipe is provided with a groove body, one end of the insert block is inserted into the water guiding pipe from the groove body, the other end of the insert block extends out of the pipe wall of the water guiding pipe and is connected with the button, and a first spring is provided between the button and the water guiding pipe.

3. The portable pet water feeder according to claim 2, wherein the end of the insert block is L-shaped, and the end of the insert block is provided in parallel with the pipe wall of the water guiding pipe.

4. The portable pet water feeder according to claim 1, wherein the partition plate is provided with an air inlet hole, the upper cover is further provided with a water locking component, the water locking component comprises a slider, a hole blocking member and a second spring, the slider is provided with a hole blocking member, the hole blocking member is provided toward the air inlet hole, and the outer wall of the hole blocking member is sleeved with a second spring.

5. The portable pet water feeder according to claim 4, wherein the top of the slider is provided with a first groove and a second groove with different depths, a water locking switch is provided on the upper cover, the water locking switch is provided with a protruding end, and the protruding end is provided perpendicular to the slider and buckled in the first groove or the second groove.

6. The portable pet water feeder according to claim 1, wherein a filter tray is provided in the cup body, and a filter purification component is placed in the filter tray.

7. The portable pet water feeder according to claim 6, wherein the filter purification component comprises a charcoal bag.

8. The portable pet water feeder according to claim 1, wherein the drinking slider is provided with a drinking cavity, and the water outlet nozzle is connected to the drinking cavity.
